(19) United States
(12) Patent Application Publication
(10) Pub. No.: US 2026/0220038 A1
(43) Pub. Date: Jul. 30, 2026

(54) CHANNEL MODEL IMPLEMENTATION CIRCUIT, CHANNEL MODEL IMPLEMENTATION METHOD, MEMORY CONTROLLER, ELECTRONIC DEVICE AND MEMORY SYSTEM

(71) Applicant: Yangtze Memory Technologies Co., Ltd., Wuhan (CN)

(72) Inventors: Zhiwei Zhuang, Wuhan (CN); Xin Zhou, Wuhan (CN); Xikui Cui, Wuhan (CN)

(21) Appl. No.: 19/058,642

(22) Filed: Feb. 20, 2025

(30) Foreign Application Priority Data
Jan. 24, 2025 (CN) 202510120897.X

(51) Int. Cl. G06F 12/02

(52) U.S. Cl. CPC G06F 12/0246

(57) ABSTRACT

According to one aspect, a channel model implementation circuit is provided. The channel model implementation circuit may include at least one channel model implementation sub-circuit. The at least one channel model implementation sub-circuit may include a random number generation circuit configured to generate a random number. The at least one channel model implementation sub-circuit may include a channel output information determination circuit configured to receive one sub-data of channel input information. The channel output information determination circuit may be configured to determine channel output information corresponding to the sub-data, based on the random number, random number interval group information, and the sub-data. The sub-data may include at least two data states, and the random number interval group information may include a mapping relationship between a plurality of random number intervals and a plurality of channel output information under different data states.

### CROSS-REFERENCE TO RELATED APPLICATIONS

This application claims the benefit of priority to Chinese Application No. 202510120897.X, filed on Jan. 24, 2025, which is incorporated herein by reference in its entirety.

### TECHNICAL FIELD

The present disclosure relates to electronic information technology, involving but not limited to a channel model implementation circuit, a channel model implementation method, a memory controller, an electronic device, and a memory system.

### BACKGROUND

In recent years, information technology has experienced rapid development, and information exchange in current society is becoming increasingly frequent. Various channel models are often used for data processing in fields such as communication, electronic, and semiconductor, etc., as an example, channel model(s) can be applied to the process of data encoding and decoding. However, the implementation of channel model(s) requires complex computations, thereby a significant amount of hardware and software resources may be occupied.

### SUMMARY

According to one aspect of the present disclosure, a channel model implementation circuit is provided. The channel model implementation circuit may include at least one channel model implementation sub-circuit. The at least one channel model implementation sub-circuit may include a random number generation circuit. The random number generation circuit may be configured to generate a random number. The at least one channel model implementation sub-circuit may include a channel output information determination circuit. The channel output information determination circuit may be configured to receive one sub-data of channel input information. The channel output information determination circuit may be configured to determine channel output information corresponding to the sub-data, based on the random number, random number interval group information, and the sub-data. The sub-data may include at least two data states, and the random number interval group information may include a mapping relationship between a plurality of random number intervals and a plurality of channel output information under different data states.

In some implementations, the channel output information determination circuit may be further configured to receive the random number interval group information. In some implementations, the sub-data may include N data states, the random number interval group information may include N sub-random number interval group information in a one-to-one correspondence with the N data states, and N is an integer greater than 1. In some implementations, a P-th sub-random number interval group information may include a mapping relationship, corresponding to a P-th data state, between the plurality of random number intervals and the plurality of channel output information, and P may be an integer greater than or equal to 1, and less than or equal to N.

In some implementations, in the P-th sub-random number interval group information, a size of the random number interval may be positively correlated with a probability of the P-th data state being mapped to corresponding channel output information.

In some implementations, the channel output information determination circuit may be configured to determine the random number interval corresponding to the random number in a first sub-random number interval group information to a N-th sub-random number interval group information. In some implementations, the channel output information determination circuit may be configured to determine the channel output information corresponding to the sub-data based on the random number interval in which the random number is located and a data state of the sub-data.

In some implementations, the channel output information determination circuit may include a first comparison circuit and a first selection circuit. In some implementations, the first comparison circuit may be configured to compare the random number with the plurality of random number intervals in each sub-random number interval group information. In some implementations, the first comparison circuit may be configured to determine N random number intervals corresponding to the random number in the first sub-random number interval group information to the N-th sub-random number interval group information. In some implementations, the first comparison circuit may be configured to output N channel output information corresponding to the N random number intervals. In some implementations, the first selection circuit may be configured to output one of the N channel output information based on the data state of the sub-data.

In some implementations, the sub-data may include a first data state and a second data state. In some implementations, a probability of the first data state being mapped to channel output information N may be equal to a probability of the second data state being mapped to channel output information M, where N+M=0, and N and M may both be integers. In some implementations, the first data state may correspond to first sub-random number interval group information, and the second data state corresponds to second sub-random number interval group information. In some implementations, the plurality of random number intervals in the first sub-random number interval group information may be the same as the plurality of random number intervals in the second sub-random number interval group information. In some implementations, channel output information in the first sub-random number interval group information and channel output information in the second sub-random number interval group information corresponding to a same random number interval may be complementary. In some implementations, the first comparison circuit may be configured to compare the random number with the plurality of random number intervals in the first sub-random number interval group information. In some implementations, the first comparison circuit may be configured to determine a random number interval corresponding to the random number. In some implementations, the first comparison circuit may be configured to output a first channel output information corresponding to the random number interval. In some implementations, the first selection circuit may be configured to output the first channel output information based on the data state of the sub-data being the first data state. In some implementations, the first selection circuit may be configured to output an inverted version of the first channel output information based on the data state of the sub-data being the second data state.

In some implementations, the channel output information determination circuit may be configured to determine one sub-random number interval group information corresponding to the sub-data in the N sub-random number interval group information, based on a data state of the sub-data. In some implementations, the channel output information determination circuit may be configured to determine the random number interval corresponding to the random number in the sub-random number interval group information. In some implementations, the channel output information determination circuit may be configured to output the channel output information corresponding to the random number interval.

In some implementations, the channel output information determination circuit may include a second selection circuit. In some implementations, the second selection circuit may be configured to output one sub-random number interval group information corresponding to the data state of the sub-data in the N sub-random number interval group information based on the data state of the sub-data. In some implementations, the channel output information determination circuit may include a second comparison circuit. In some implementations, the second comparison circuit may be configured to compare the random number with the plurality of random number intervals in the one sub-random number interval group information. In some implementations, the second comparison circuit may be configured to determine the random number interval corresponding to the random number. In some implementations, the second comparison circuit may be configured to output the channel output information corresponding to the random number interval.

In some implementations, the channel model implementation circuit of may include a storage component configured to store the random number interval group information.

In some implementations, the sub-data may include Q bits, the sub-data may include 2^{Q} data states, and Q may include a positive integer.

In some implementations, the channel input information may include encoded data, and the channel output information may include a noised fixed-point log-likelihood ratio.

According to another aspect of the present disclosure, a memory controller is provided. The memory controller may include an error correction circuit. The error correction circuit may include a channel model implementation circuit. The channel model implementation circuit may include at least one channel model implementation sub-circuit. The at least one channel model implementation sub-circuit may include a random number generation circuit. The random number generation circuit may be configured to generate a random number. The at least one channel model implementation sub-circuit may include a channel output information determination circuit. The channel output information determination circuit may be configured to receive one sub-data of channel input information. The channel output information determination circuit may be configured to determine channel output information corresponding to the sub-data, based on the random number, random number interval group information, and the sub-data. The sub-data may include at least two data states, and the random number interval group information may include a mapping relationship between a plurality of random number intervals and a plurality of channel output information under different data states. The error correction circuit may include an encoding circuit. The error correction circuit may include a decoding circuit. The memory controller may include a control unit configured to output original data. The encoding circuit may be configured to encode the original data to generate the channel input information, and the decoding circuit may be configured to obtain decoded data based on a check matrix to be tested and the channel output information corresponding to each sub-data of the channel input information.

In some implementations, the control unit may be further configured to perform simulation or calculation on user data, to determine probabilities of the user data being mapped to the plurality of channel output information. In some implementations, the control unit may be further configured to generate the plurality of random number intervals in one-to-one correspondence with the plurality of channel output information based on probabilities of the user data being mapped to the plurality of channel output information and a random number preset value. In some implementations, the random number preset value may be greater than or equal to a random number generated by the channel model implementation sub-circuit. In some implementations, the control unit may be further configured to generate the random number interval group information including the mapping relationship between the plurality of random number intervals and the plurality of channel output information.

In some implementations, the control unit may be configured to perform an operation on the random number preset value and probabilities of the user data being mapped to the plurality of channel output information respectively, to obtain sizes of a plurality of random number intervals in one-to-one correspondence with the plurality of channel output information. In some implementations, the control unit may be configured to generate the random number intervals based on the sizes of the random number intervals.

In some implementations, the control unit may be configured to perform calculation on the user data with a channel function, and determine probabilities of each data state of the user data being mapped to the plurality of channel output information.

In some implementations, the control unit may be configured to compare the decoded data with the original data, and output a decoding performance test result. In some implementations, the control unit may be configured to determine a check matrix for a decoding operation based on decoding performance test results corresponding to a plurality of check matrices to be tested.

In some implementations, at least one of the encoding circuit, the control unit, the decoding circuit, and the channel model implementation circuit may include an application specific integrated circuit.

According to a further aspect of the present disclosure, an electronic device is provided. The electronic device may include a processor and a memory controller. The memory controller may include an error correction circuit. The error correction circuit may include a channel model implementation circuit. The channel model implementation circuit may include at least one channel model implementation sub-circuit. The at least one channel model implementation sub-circuit may include a random number generation circuit. The random number generation circuit may be configured to generate a random number. The at least one channel model implementation sub-circuit may include a channel output information determination circuit. The channel output information determination circuit may be configured to receive one sub-data of channel input information. The channel output information determination circuit may be configured to determine channel output information corresponding to the sub-data, based on the random number, random number interval group information, and the sub-data. The sub-data may include at least two data states, and the random number interval group information may include a mapping relationship between a plurality of random number intervals and a plurality of channel output information under different data states. The error correction circuit may include an encoding circuit. The error correction circuit may include a decoding circuit. The memory controller may include a control unit configured to output original data. The encoding circuit may be configured to encode the original data to generate the channel input information, and the decoding circuit may be configured to obtain decoded data based on a check matrix to be tested and the channel output information corresponding to each sub-data of the channel input information. The processor may be configured to generate the random number interval group information, and the control unit is further configured to transmit the random number interval group information to the channel model implementation circuit.

In some implementations, the processor may be configured to perform simulation or calculation on user data, to determine probabilities of the user data being mapped to the plurality of channel output information. In some implementations, the processor may be configured to generate the plurality of random number intervals in one-to-one correspondence with the plurality of channel output information based on probabilities of the user data being mapped to the plurality of channel output information and a random number preset value. In some implementations, the random number preset value may be greater than or equal to a random number generated by the channel model implementation sub-circuit. In some implementations, the processor may be configured to generate the random number interval group information including the mapping relationship between the plurality of random number intervals and the plurality of channel output information.

In some implementations, the processor may be configured to perform an operation on the random number preset value and probabilities of the user data being mapped to the plurality of channel output information respectively, to obtain sizes of a plurality of random number intervals in one-to-one correspondence with the plurality of channel output information. In some implementations, the processor may be configured to generate the random number intervals based on the sizes of the random number intervals.

In some implementations, the processor may be configured to perform calculation on the user data with a channel function, and determine probabilities of each data state of the user data being mapped to the plurality of channel output information.

According to yet another aspect of the present disclosure, a method of channel model implementation is provided. The method may include generating a random number. The method may include determining channel output information corresponding to each sub-data of channel input information based on the random number, random number interval group information, and each sub-data of the channel input information. The sub-data may include at least two data states, and the random number interval group information may include a mapping relationship between a plurality of random number intervals and a plurality of channel output information under different data states.

In some implementations, the method may include receiving the random number interval group information. In some implementations, the sub-data may include N data states, the random number interval group information may include N sub-random number interval group information in a one-to-one correspondence with the N data states, and N may include an integer greater than 1. In some implementations, P-th sub-random number interval group information may include a mapping relationship, corresponding to a P-th data state, between the plurality of random number intervals and the plurality of channel output information, and P may be an integer greater than or equal to 1, and less than or equal to N.

In some implementations, in the P-th sub-random number interval group information, a size of the random number interval may be positively correlated with a probability of the P-th data state being mapped to corresponding channel output information.

In some implementations, the generating the random number may include generating a plurality of random numbers. In some implementations, the number of the random numbers may be the same as the number of sub-data of the channel input information. In some implementations, the determining the channel output information corresponding to each sub-data of the channel input information, based on the random number, the random number interval group information, and the channel input information may include determining the random number interval corresponding to each of the random numbers in a first sub-random number interval group information to a N-th sub-random number interval group information. In some implementations, the determining the channel output information corresponding to each sub-data of the channel input information, based on the random number, the random number interval group information, and the channel input information may include determining the channel output information corresponding to each sub-data of the channel input information based on the random number interval in which each of the random numbers is located and a data state of each sub-data of the channel input information.

In some implementations, the determining the random number interval corresponding to each of the random numbers in the first sub-random number interval group information to the N-th sub-random number interval group information may include comparing the random number with the plurality of random number intervals in each sub-random number interval group information. In some implementations, the determining the random number interval corresponding to each of the random numbers in the first sub-random number interval group information to the N-th sub-random number interval group information may include determining N random number intervals corresponding to the random number in the first sub-random number interval group information to the N-th sub-random number interval group information. In some implementations, the determining the channel output information corresponding to each sub-data of the channel input information based on the random number interval in which each of the random numbers is located and the data state of each sub-data in the channel input information may include outputting N channel output information corresponding to the N random number intervals. In some implementations, the determining the channel output information corresponding to each sub-data of the channel input information based on the random number interval in which each of the random numbers is located and the data state of each sub-data in the channel input information may include outputting one of the N channel output information based on the data state of one sub-data of the channel input information.

In some implementations, the sub-data may include a first data state and a second data state. In some implementations, a probability of the first data state being mapped to the N channel output information may be equal to a probability of the second data state being mapped to M channel output information, N+M=0, and N and M may be both integers. In some implementations, the first data state may correspond to a first sub-random number interval group information, and the second data state may correspond to a second sub-random number interval group information. In some implementations, the plurality of random number intervals in the first sub-random number interval group information may be the same as the plurality of random number intervals in the second sub-random number interval group information. In some implementations, channel output information in the first sub-random number interval group information and channel output information in the second sub-random number interval group information corresponding to a same random number interval may be complementary. In some implementations, the method may include comparing the random number with the plurality of random number intervals in the first sub-random number interval group information, determining a random number interval corresponding to the random number, and outputting a first channel output information corresponding to the random number interval. In some implementations, the method may include outputting the first channel output information based on the data state of one sub-data of the channel input information being the first data state, or outputting an inverted version of the first channel output information based on the data state of one sub-data of the channel input information being the second data state.

In some implementations, the generating the random number may include generating a plurality of random numbers. In some implementations, the number of the random numbers is the same as the number of sub-data of the channel input information. In some implementations, the determining the channel output information corresponding to each sub-data of the channel input information based on the random number, the random number interval group information, and the channel input information may include determining one sub-random number interval group information corresponding to each of the sub-data in the N sub-random number interval group information based on a data state of each of the sub-data. In some implementations, the determining the channel output information corresponding to each sub-data of the channel input information based on the random number, the random number interval group information, and the channel input information may include determining the random number interval corresponding to each of the random numbers in the sub-random number interval group information, and outputting channel output information corresponding to the random number interval.

According to yet further aspect of the present disclosure, a memory system is provided. The memory system may include at least one memory device and a memory controller coupled to the memory device and configured to control the memory device. The memory controller may include an error correction circuit. The error correction circuit may include a channel model implementation circuit. The channel model implementation circuit may include at least one channel model implementation sub-circuit. The at least one channel model implementation sub-circuit may include a random number generation circuit. The random number generation circuit may be configured to generate a random number. The at least one channel model implementation sub-circuit may include a channel output information determination circuit. The channel output information determination circuit may be configured to receive one sub-data of channel input information. The channel output information determination circuit may be configured to determine channel output information corresponding to the sub-data, based on the random number, random number interval group information, and the sub-data. The sub-data may include at least two data states, and the random number interval group information may include a mapping relationship between a plurality of random number intervals and a plurality of channel output information under different data states. The error correction circuit may include an encoding circuit. The error correction circuit may include a decoding circuit. The memory controller may include a control unit configured to output original data. The encoding circuit may be configured to encode the original data to generate the channel input information, and the decoding circuit may be configured to obtain decoded data based on a check matrix to be tested and the channel output information corresponding to each sub-data of the channel input information.

In an example of the present disclosure, the channel output information determination circuit determines channel output information corresponding to one sub-data based on the random number, the random number interval group information, and the sub-data of the channel input information. The sub-data includes at least two data states, and the random number interval group information includes a mapping relationship between a plurality of random number intervals and a plurality of channel output information under different data states. That is, the techniques of present disclosure may generate the mapping relationship between the plurality of random number intervals and the plurality of channel output information in advance by simulation statistics and the like, and the channel model implementation circuit directly determines the channel output information corresponding to each sub-data of the channel input information based on the random number interval group information including the above mapping relationship, so that the channel model implementation circuit does not need to perform a large amount of computations, which may be beneficial for saving software resources and hardware resources.

### BRIEF DESCRIPTION OF DRAWINGS

FIG. 1 is a first schematic diagram of an example system having a memory system according to an implementation of the present disclosure.

FIG. 2 is a schematic diagram of an example memory card having a memory system according to an implementation of the present disclosure.

FIG. 3 is a schematic diagram of an example solid state drive having a memory system according to an implementation of the present disclosure.

FIG. 4 is a schematic diagram of an example memory device including a peripheral circuit according to an implementation of the present disclosure.

FIG. 5 is a schematic diagram of an example memory including a memory array and a peripheral circuit according to an implementation of the present disclosure.

FIG. 6 is a second schematic diagram of an example system having a memory system according to an implementation of the present disclosure.

FIG. 7 is a process of generating a noised fixed-point log-likelihood ratio with a channel model according to an implementation of the present disclosure.

FIG. 8 is a schematic diagram of a channel model implementation circuit according to an implementation of the present disclosure.

FIG. 9 is a schematic diagram of random number interval group information according to an implementation of the present disclosure.

FIG. 10 is a schematic diagram of probabilities of different data states of sub-data being mapped to respective channel output information according to an implementation of the present disclosure.

FIG. 11 is a schematic diagram of probabilities of different data states of channel input information being mapped to respective channel output information obeying normal distribution according to an implementation of the present disclosure.

FIG. 12 is a first schematic structural diagram of a channel output information determination circuit according to an implementation of the present disclosure.

FIG. 13 is a second schematic structural diagram of a channel output information determination circuit according to an implementation of the present disclosure.

FIG. 14 is a schematic diagram of an electronic device according to an implementation of the present disclosure.

FIG. 15 is a schematic diagram of a control unit, an encoding circuit, a decoding circuit and a channel model implementation circuit according to an implementation of the present disclosure.

FIG. 16 is a flowchart of a channel model implementation method according to an implementation of the present disclosure.

FIG. 17 is a schematic flowchart of a soft decoding performance test of an LDPC code check matrix according to an implementation of the present disclosure.

### DETAILED DESCRIPTION

Example implementations disclosed in the present disclosure will be described in more detail below with reference to the drawings. Although example implementations of the present disclosure are illustrated in the drawings, it should be understood that the present disclosure may be implemented in various manners and should not be limited to the implementations set forth herein. Rather, these implementations are provided so that the present disclosure may be understood more thoroughly and the scope of the present disclosure may be fully presented to those skilled in the art.

Numerous details are introduced hereinafter in order to provide a more thorough understanding of the present disclosure. However, it would be obvious to one skilled in the art that, the present disclosure may be practiced without one or more of these details. In other examples, in order to avoid a confusion with the present disclosure, some technical features known in the art are not described; that is, not all the features of the actual implementations are described herein, and well-known functions and structures are not described in detail.

In the drawings, the same references refer to the same elements throughout.

It should be appreciated that terms of spatial relationship such as “beneath,” “below,” “lower,” “under”, “above”, “upper,” etc., may be used herein for ease of description, so as to describe the relationships between one element or feature and other elements or features shown in the drawings. It should be appreciated that, in addition to the orientations shown in the drawings, the terms of spatial relationship are intended to further include different orientations of a device in use and operation. For example, if the devices in the drawings are inverted, then elements or features described as “below” or “under” or “beneath” other elements or features would be oriented “on” the other elements or features. Thus, the example terms “below” and “under” may comprise both upper and lower orientations. The devices may be additionally oriented (rotated 90 degrees or other orientations) and the spatial description terms used herein may be interpreted accordingly.

A term used herein is merely for the purpose of describing an implementation and is not limiting the present disclosure. As used herein, unless the context indicates otherwise clearly, the singular form of “a”, “an” and “said/the” are intended to comprise the plural form as well. It should also be understood that the terms of “composed of” and/or “comprising”, when used in the description, indicates a presence of the stated features, integers, steps, operations, elements and/or components, rather than exclude a presence and addition of one or more other features, integers, steps, operations, elements, components and/or groups. As used herein, term “and/or” comprises any and all combinations of the related listed items.

In some examples, various channel models are used for data processing in fields such as communication, electronic, and semiconductor, etc. For example, binary phase shift keying (BPSK) and additive white Gaussian noise (AWGN) model may be used to obtain the noised soft information, thereby a performance test on low density parity check (LDPC) soft decoding may be carried out. LDPC code is a sparse matrix-based parallel iterative decoding algorithm, with a performance approximating Shannon limit, which is simple to decode and parallel operation enabled, it has become one of the most widely used error correcting codes. For example, LDPC code can be used for error detection and correction of data in memory.

The memory in the present disclosure may be a volatile memory, including but not limited to a static random access memory (SRAM), a synchronous static random access memory (SSRAM), a dynamic random access memory (DRAM), a synchronous dynamic random access memory (SDRAM), a double data rate (DDR) synchronous dynamic random access memory, an enhanced synchronous dynamic random access memory (ESDRAM), a synclink dynamic random access memory (SLDRAM), a direct rambus random access memory (DRRAM), or the like; the memory may also be a non-volatile memory, including but not limited to a read only memory (ROM), a programmable read-only memory (PROM), an erasable programmable read-only memory (EPROM), an electrically erasable programmable read-only memory (EEPROM), a ferromagnetic random access memory (FRAM), a flash memory, or the like. The present disclosure will be described hereinafter by taking a memory system including a NAND-type memory as an example.

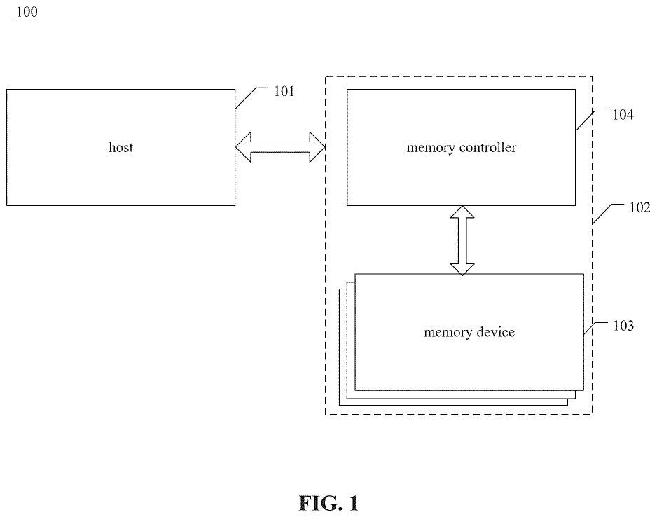

FIG. 1 is a schematic diagram of an example system having a memory system according to an implementation of the present disclosure. In an example of the present disclosure, the system 100 may be a mobile phone, a desktop computer, a laptop computer, a tablet computer, a vehicle computer, a game console, a printer, a positioning device, a wearable electronic device, a smart sensor, a virtual reality (VR) device, an augmented reality (AR) device, or any other suitable electronic device having a memory therein. As shown in FIG. 1, the system 100 may include a host 101 and a memory system 102, the memory system 102 may include one or more memory devices 103 and a memory controller 104. The host 101 may include a processor of an electronic device, for example, a Central Processing Unit (CPU), or a System on a Chip (SoC), such as an application processor (AP). The host 101 may be configured to transmit data to or receive data from the memory system 102.

In some examples, the memory controller 104 is coupled to the memory device 103 and the host 101, and is configured to control the memory device 103. The memory controller 104 may manage data stored in the memory device 103 and communicate with the host 101. In some examples, the memory controller 104 is designed to operate in a low duty cycle environment, such as in a secure digital card, Compact Flash Card (CFC), Universal Serial Bus (USB) flash driver, or to operate in other medium for use in electronic device such as personal computer, digital camera, mobile phone, and the like. In further examples, the memory controller 104 is designed to operate in a high duty cycle environment, such as in a solid state disk or embedded Multi-Media Card (eMMC).

In some examples, the memory controller 104 and the one or more memory devices 103 may be integrated into various types of storage devices, that is, the memory system 102 may be implemented and packaged into different types of terminal electronic products.

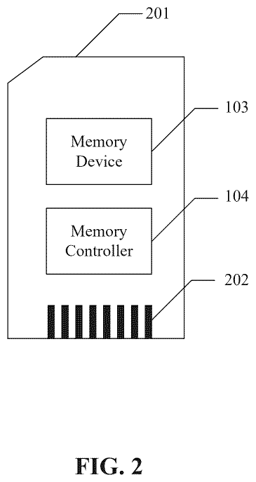

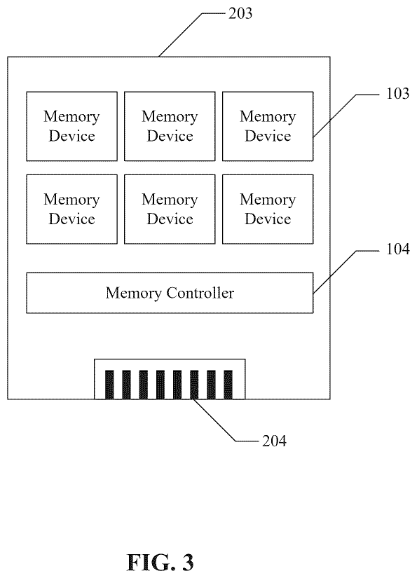

In one example as shown in FIG. 2, the memory controller 104 and a single memory device 103 may be integrated into a memory card 201. The memory card 201 may be one of a compact flash memory card, a Smart Media Card (SMC), a Memory Stick (MS), a Multi-Media Card (MMC), such as RS-MMC, MMCmicro, eMMC or the like, a secure digital card, such as Mini SD card, Micro SD card, SDHC card or the like, and a universal flash memory card. The memory card 201 may also include a memory card connector 202 that couples the memory card 201 with a host-side device (e.g., host 101 in FIG. 1). In another example as shown in FIG. 3, the memory controller 104 and a plurality of memory devices 103 may be integrated into SSD 203. The SSD 203 may also include an SSD connector 204 that couples SSD 203 with a host-side device (e.g., host 101 in FIG. 1). In some examples, the storage capacity and/or operating speed of SSD 203 is greater than the storage capacity and/or operating speed of the memory card 201.

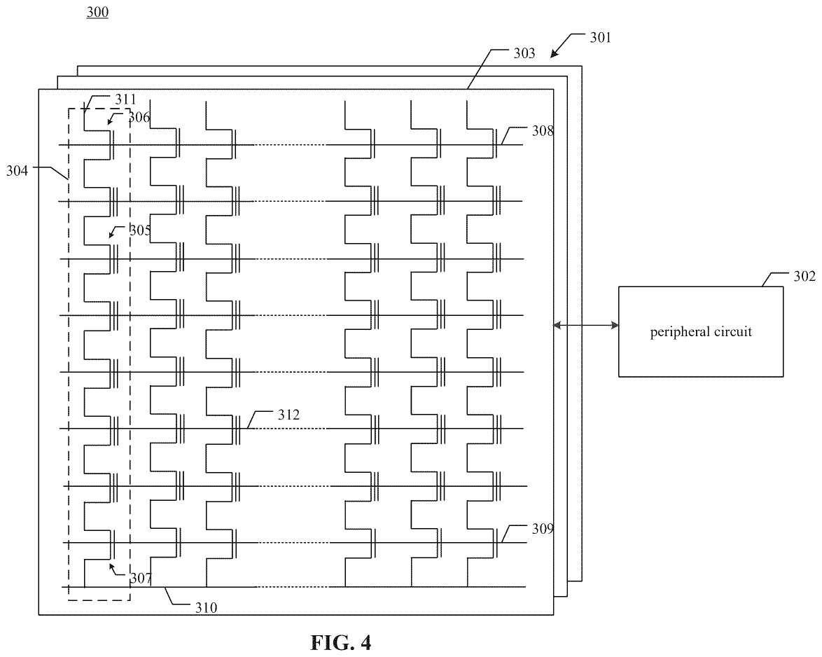

FIG. 4 is a schematic circuit diagram of an example memory device 300 including a peripheral circuit according to an implementation of the present disclosure. The memory device 300 may be an example of the memory device 103 in FIG. 1. The memory device 300 may include a memory array 301 and a peripheral circuit 302 coupled to the memory array 301. Taking the memory array 301 of a 3D NAND memory array as an example for description, where a memory cell 305 is a NAND memory cell, the memory cell 305 is provided in the form of an array of memory cell strings 304, each memory cell string 304 extends vertically above a substrate (not shown). In some examples, each memory cell string 304 includes a plurality of memory cells 305 coupled in series and stacked vertically. Each memory cell 305 may maintain a continuous analog value, e.g., voltage or charge, which depends on the number of electrons trapped within the region of the memory cell 305. Each memory cell 305 may be a memory cell of floating gate type which includes a floating gate transistor or a memory cell of charge trap type which includes a charge trap transistor.

In some examples, each memory cell 305 is a Single Level Cell (SLC), having two possible memory states and thus may store one bit of data. For example, a first memory state “0” may correspond to a first voltage range and a second memory state “1” may correspond to a second voltage range. In some examples, each memory cell 305 is a multi-level cell, which is capable of storing more than a single bit of data in four or more memory states, e.g., a Multi-Level Cell (MLC) storing two bits per cell, a Triple Level Cell (TLC) storing three bits per cell, or a Quad-Level Cell (QLC) storing four bits per cell.

As shown in FIG. 4, each memory cell string 304 may include a Bottom Select Transistor (BST) 307 at its source end and a Top Select Transistor (TST) 306 at its drain end. The bottom select transistor 307 and the top select transistor 306 may be configured to activate a selected memory cell string 304 during read and program operations. In some examples, sources of the memory cell strings 304 in a same memory block 303 may be coupled through a Common Source Line (CSL) 310. In other words, all the memory cell strings 304 in the same memory block 303 have a common source (ACS). According to some examples, a top select transistor 306 of each memory cell string 304 is coupled to a respective Bit Line (BL) 311, data may be read or written via an output bus (not shown) from the bit line 311. In some examples, each memory cell string 304 is configured to be selected or deselected by applying a select voltage (e.g., a voltage higher than a threshold voltage of the top select transistor 306) or a deselect voltage (e.g., 0V) to a Top Select Gate (TSG) of a respective top select transistor 306 through one or more Top Select Lines (TSL) 308 and/or by applying a select voltage (e.g., a voltage higher than a threshold voltage of the bottom select transistor 307) or a deselect voltage (e.g., 0V) to a Bottom Select Gate (BSG) of a respective bottom select transistor 307 through one or more Bottom Select Lines (BSL) 309.

As shown in FIG. 4, the memory cell string 304 may be organized into a plurality of memory blocks 303, each of the memory blocks 303 may have a common source line 310. In some examples, each memory block 303 is a basic data unit for an erase operation, i.e., all the memory cells 305 on a same memory block 303 may be erased simultaneously. To erase the memory cells 305 in a selected memory block, a common source line 310 coupled to the selected memory block and an unselected memory block(s) in the same plane as the selected memory block may be biased with an erase voltage. It should be understood that, in some examples, an erase operation may be performed at a half-memory block level, at a quarter-memory block level, or at a level with any suitable number of memory blocks or any suitable fraction of a memory block. Memory cells 305 of adjacent memory cell strings 304 may be coupled by a word line 312, the word line 312 selects which row of memory cells 305 are affected by read or program operations.

In some examples, the peripheral circuit 302 may include any suitable analog, digital, and mixed-signal circuit, in order to enable an operation on the memory array 301 by applying at least one of a voltage signal or a current signal to each target memory cell 305 and sensing at least one of a voltage signal or a current signal from each target memory cell 305 through the bit line 311, the word line 312, the common source line 310, the bottom select line 309, and the top select line 308. The peripheral circuit 302 may include various types of peripheral circuits formed with metal-oxide-semiconductor technology.

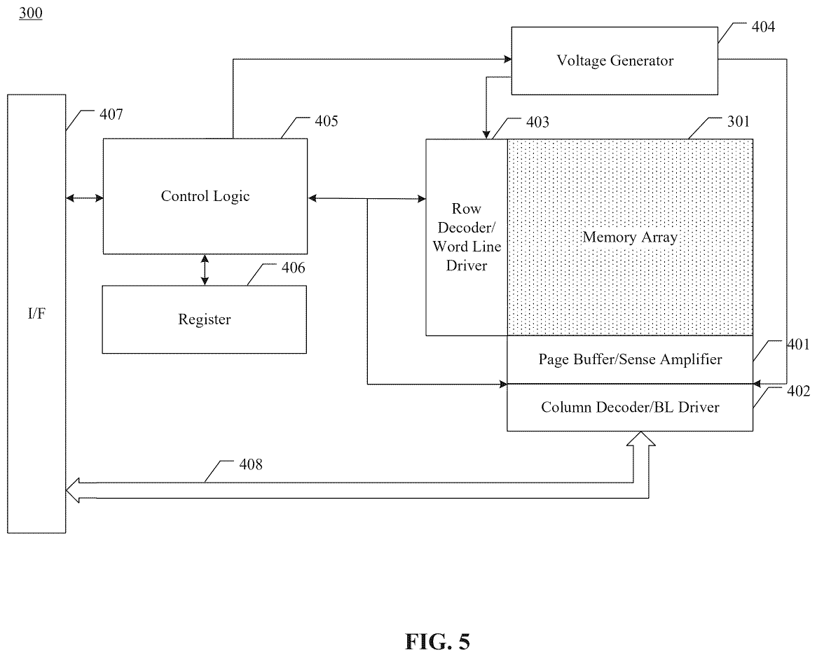

FIG. 5 shows some example peripheral circuits, the peripheral circuit 302 includes page buffer/sensing amplifier 401, a column decoder/bit line driver 402, a row decoder/word line driver 403, a voltage generator 404, a control logic 405, a register bank 406, a flash memory interface 407, and a data bus 408. It should be understood that, in some examples, additional peripheral circuit(s) not shown in FIG. 5 may also be included.

The page buffer/sensing amplifier 401 may be configured to read data from the memory array 301 and program (write) data to the memory array 301 according to a control signal from the control logic 405. In one example, the page buffer/sensing amplifier 401 may store a page of programming data (write data) to be programmed to the memory array 301. In another example, the page buffer/sensing amplifier 401 may perform a programming verification operation to ensure that the data has been properly programmed into memory cells coupled to the selected word line. In yet another example, the page buffer/sensing amplifier 401 may also sense a low power signal from the bit line, representing a data bit stored in the memory cell, and may amplify a small voltage swing to an identifiable logic level in a read operation. The column decoder/bit line driver 402 may be configured to be controlled by the control logic 405 and select one or more memory cell strings by applying a bit line voltage generated from the voltage generator 404.

The row decoder/word line driver 403 may be configured to be controlled by the control logic 405 and select/deselect a memory block of the memory array 301 and select/deselect a word line of the memory block. The row decoder/word line driver 403 may also be configured to drive a word line using a word line voltage generated from the voltage generator 404. In some examples, the row decoder/word line driver 403 may also select/deselect and drive a bottom select line and a top select line. As described in detail hereinafter, the row decoder/word line driver 403 is configured to perform a programming operation on memory cells coupled to the selected word line(s). The voltage generator 404 may be configured to be controlled by the control logic 405 and generate a word line voltage (e.g., a reading voltage, a programming voltage, a passing voltage, a local voltage, a verifying voltage, etc.), a bit line voltage, and a source line voltage to be supplied to the memory array 301.

The control logic 405 may be coupled to each peripheral circuit described above, and configured to control operation of each peripheral circuit. The register bank 406 may be coupled to the control logic 405, and includes a status register, a command register, and an address register for storing status information, command operation code (OP code), and command address for controlling the operation of each peripheral circuit. The flash memory interface 407 may be coupled to the control logic 405 and act as a control buffer to buffer a control command received from a host-side device (not shown) and relay it to the control logic 405, and buffer status information received from the control logic 405 and relay it to a memory controller. The flash memory interface 407 may also be coupled to the column decoder/bit line driver 402 via the data bus 408, and act as a data I/O interface and a data buffer to buffer data and relay it to the memory array 301 or buffer and relay data from the memory array 301.

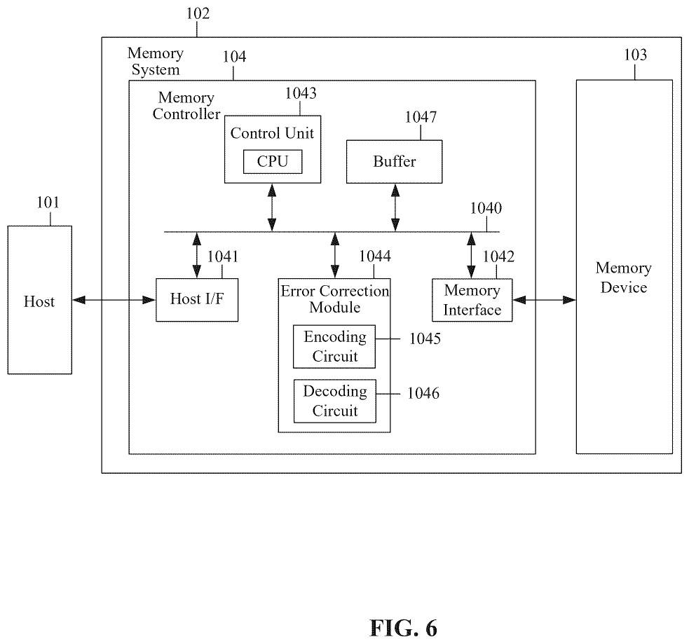

FIG. 6 is a schematic diagram of a system including a host and a memory system according to an implementation of the present disclosure. As shown in FIG. 6, the memory system 102 is connected to the host 101, where the memory system 102 may include a memory controller 104 and a memory device 103. The memory controller 104 is configured to control the memory device 103 to perform operations such as read, write, and erase, etc. The memory controller 104 and the memory device 103 may also be coupled in any suitable manner. The memory controller 104 may include a host interface (I/F) 1041, a memory interface (I/F) 1042, a control unit 1043, an error correction circuit 1044, a buffer 1047, and a bus 1040. The host interface 1041 is a connection interface connected between the host 101 and the memory controller 104. The host interface 1041 allows the host 101 and the memory controller 104 to communicate according to a certain protocol, transmit read and write requests and perform other operations. The memory interface 1042 is a connection interface between the memory controller 104 and the memory device 103. The memory interface 1042 is configured to implement data transfer between the memory controller 104 and the memory device 103. The control unit 1043 is configured to integrally control the memory system 102.

In some examples, the control unit 1043 may include one or more units having logical operation capability, for example, at least one of a Central Processing Unit (CPU) or a Micro Controller Unit (MCU), or the like.

In some examples, the buffer 1047 is configured to buffer data, and the buffer 1047 may be a volatile memory device with a relatively fast read/write speed, such as at least one of a Static Random Access Memory (SRAM) or a Dynamic Random Access Memory (DRAM).

In some examples, the error correction circuit 1044 may be configured to encode and decode data in the memory system with an error correcting code technology. The error correction circuit 1044 may include an encoding circuit 1045 and a decoding circuit 1046, where the encoding circuit 1045 may be configured to encode the data to be written into the memory device in a write operation. The decoding circuit 1046 may be configured to decode the codeword in the read data to be decoded in a read operation. In some examples, the decoding circuit 1046 may decode the codeword to be decoded (also referred to as coding) in a LDPC layered coding manner. The decoding circuit 1046 may decode the codeword to be decoded based on a LDPC code check matrix.

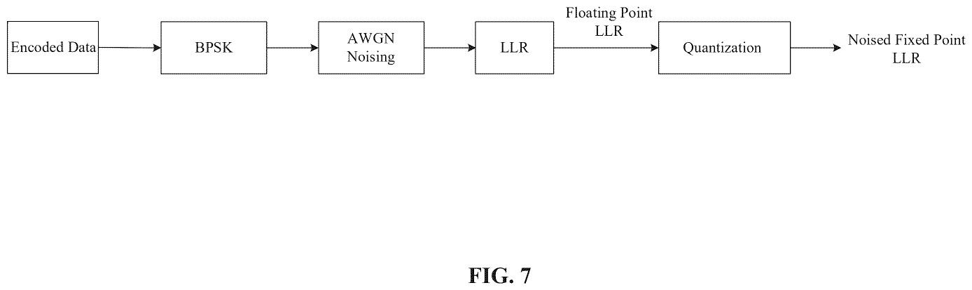

To improve the error correction capability of the memory system, some techniques perform a soft decoding performance test of the LDPC code check matrix to determine an appropriate LDPC code check matrix. For example, the above mentioned encoding circuit may generate encoded data based on original data (test data). Then, the encoding circuit may perform an operation on the encoded data with BPSK and AWGN model to obtain noised soft information (such as Log-Likelihood Ratio (LLR)). The encoding circuit generates decoded data based on the noised soft information and the LDPC code check matrix to be tested; then, the encoding circuit compares the decoded data to the original data to obtain a test result of the LDPC code check matrix to be tested; and finally, the encoding circuit determines an optimal LDPC code check matrix for coding operation in the memory system based on the test results of multiple LDPC code check matrices to be tested. However, as shown in FIG. 7, the process of generating the noised fixed-point LLR with BPSK and AWGN channel model requires complex floating-point calculation, thereby a large amount of hardware resources and software resources may be occupied.

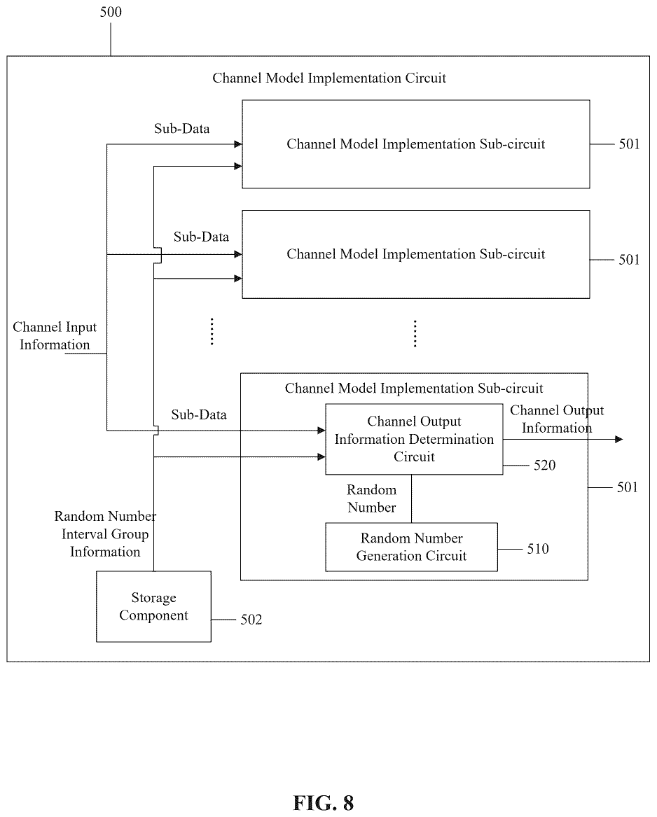

As shown in FIG. 8, an example of the present disclosure provides a channel model implementation circuit 500, including at least one channel model implementation sub-circuit 501. The channel model implementation sub-circuit 501 includes a random number generation circuit 510 and a channel output information determination circuit 520.

The random number generation circuit 510 may be configured to generate a random number.

The channel output information determination circuit 520 may be configured to receive one sub-data of channel input information; and the channel output information determination circuit 520 may be configured to determine channel output information corresponding to the sub-data based on the random number, random number interval group information, and the sub-data. The sub-data includes at least two data states, and the random number interval group information includes a mapping relationship between a plurality of random number intervals and a plurality of channel output information under different data states.

In the example of the present disclosure, the channel model implementation circuit 500 may implement a process that any channel model performs based on channel input information to generate channel output information. For example, the channel model implementation circuit 500 may implement BPSK and AWGN channel model to perform an operation on the encoded data to generate a noised fixed-point LLR (e.g., the channel output information). It should be noted that the channel model implementation circuit 500 may further implement other channel models, including but not limited to, a combination of a modulation method such as Quadrature Phase Shift Keying (QPSK), 8 Phase Shift Keying (8PSK), Quadrature Amplitude Modulation (QAM) and the like, and a channel such as Binary Symmetric Channel (BSC), Binary Erasure Channel (BEC), undistorted channel, AWGN channel and the like. For ease of understanding, the present disclosure takes BPSK and AWGN channel model as an example for description.

The channel model implementation circuit 500 may receive channel input information (such as the above-mentioned encoded data), the channel input information may include a plurality of sub-data, each sub-data includes at least two data states. For example, when the channel model uses BPSK, the sub-data may include 2 data states, e.g., such as “0” and “1”; when the channel model uses QPSK, the sub-data may include 4 data states, e.g., such as “00”, “01”, “10”, and “11”; when the channel model uses 8PSK, the sub-data may include 8 data states, e.g., such as “000”, “001”, “010”, “011”, “100”, “101”, “110”, and “111”.

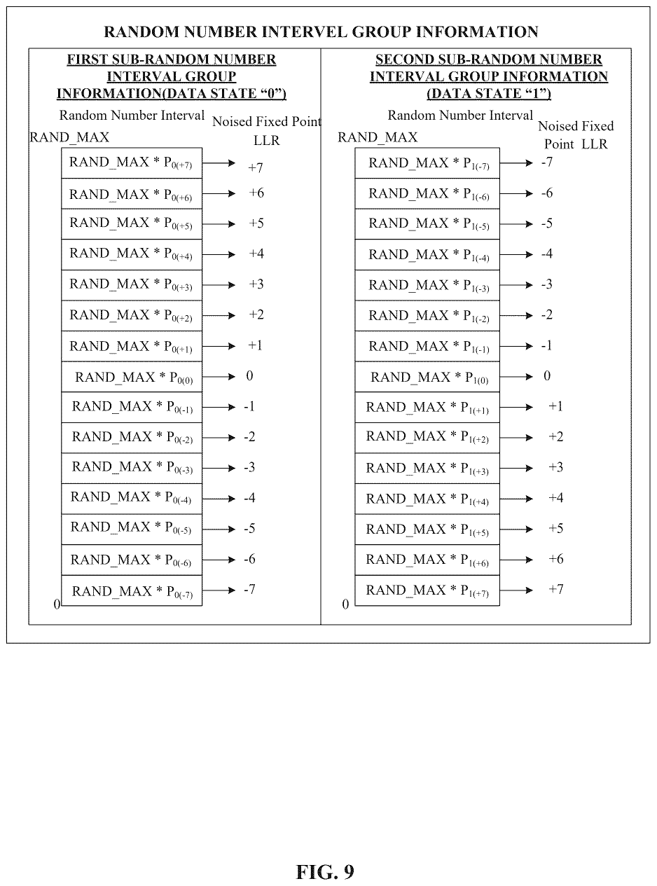

The channel model implementation circuit 500 may have at least one channel model implementation sub-circuit 501 therein. Each channel model implementation sub-circuit 501 is configured to determine channel output information corresponding to one sub-data of the channel input information based on the sub-data and random number interval group information. As shown in FIG. 9, the random number interval group information includes a mapping relationship between a plurality of random number intervals and a plurality of channel output information under different data states. The mapping relationship may be obtained in advance by simulation statistics, formula derivation calculation, and the like. For example, a device capable of logical operation, such as a processor and the like, may be used to perform channel model simulation on a large amount of user data (user data may be encoded to obtain the corresponding channel input information), to calculate probabilities of different data states of channel input information being mapped to respective channel output information.

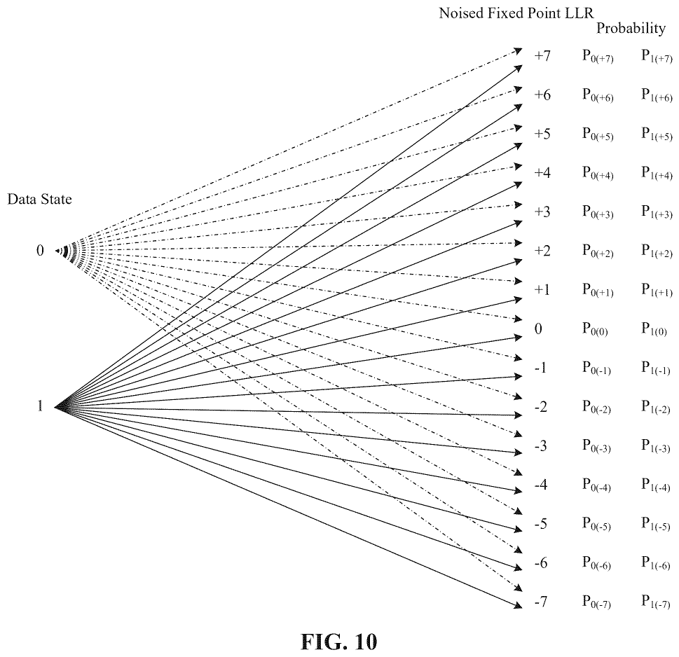

FIG. 10 illustrates probabilities P₀₍₋₇₎, P₀₍₋₆₎, P₀₍₋₅₎ . . . P₀₍₊₅₎, P₀₍₊₆₎, and P₀₍₊₇₎ of a sub-data being mapped to the noised fixed-point LLR values −7, −6, −5 . . . +5, +6, and +7 respectively under data state “0”. FIG. 10 also illustrates probabilities P₁₍₋₇₎, P₁₍₋₆₎, P₁₍₋₅₎ . . . P₁₍₊₅₎, P₁₍₊₆₎, and P₁₍₊₇₎ of a sub-data being mapped to the noised fixed-point LLR values −7, −6, −5 . . . +5, +6, and +7 respectively under data state “1”, with a BPSK and AWGN channel model.

In this way, based on the probability of different data states of the channel input information being mapped to respective channel output information, and a set random number preset value RAND_MAX (that is, a maximum random number value), a plurality of random number intervals as shown in FIG. 9 may be obtained (e.g., multiplying the random number preset value with respective probability to obtain a size of corresponding random number interval, and then performing accumulation to obtain an upper limit value and a lower limit value of each random number interval), and each random number interval may correspond to one noised fixed-point LLR value. In some examples, the probability of different data states being mapped to respective channel output information may be a cumulative probability.

It should be noted that FIG. 9 merely shows the mapping relationship between the random number interval and the channel output information under that the random number interval group information includes 2 data states “0” and “1” (that is, 2 sub-random number interval group information), the random number interval group information may further include a mapping relationship between the random number interval and the channel output information under more than 2 data states (that is, more than 2 sub-random number interval group information).

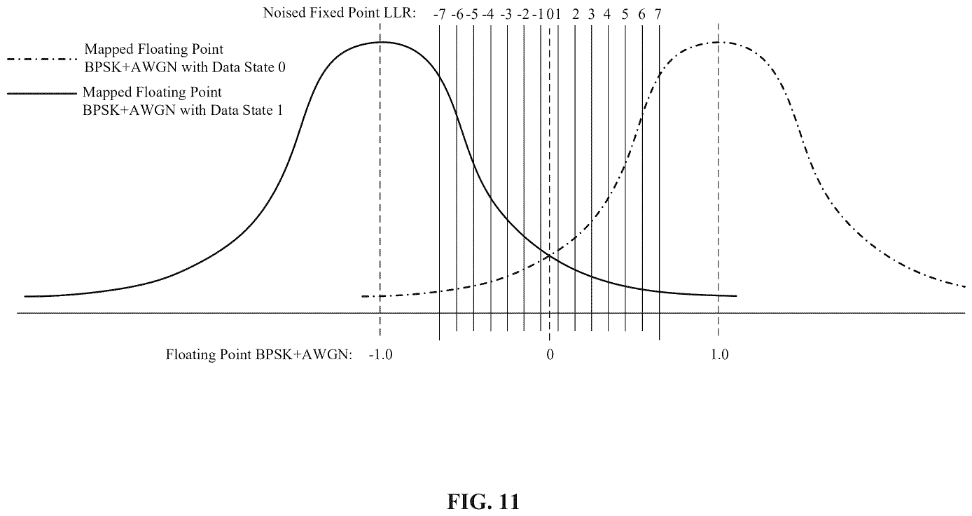

In some examples, as shown in FIG. 11, the probabilities of different data states of the channel input information being mapped to respective channel output information obey a normal distribution; therefore, the above-mentioned probabilities P₀₍₋₇₎, P₀₍₋₆₎, P₀₍₋₅₎ . . . P₀₍₊₅₎, P₀₍₊₆₎, P₀₍₊₇₎, and P₁₍₋₇₎, P₁₍₋₆₎, P₁₍₋₅₎ . . . P₁₍₊₅₎, P₁₍₊₆₎, P₁₍₊₇₎ can be obtained by calculation through a cumulative distribution function of normal distribution. It should be noted that FIG. 11 merely shows a probability distribution under BPSK and AWGN symmetric channel. In this case, when a noised fixed-point LLR value x and a noised fixed-point LLR value y are opposite to each other (i.e., x+y=0), the probability P₀₍ₓ₎ that data state “0” being mapped to the noised fixed-point LLR value x is equal to the probability P_{1(y)} that data state “1” being mapped to the noised fixed-point LLR value y.

Additionally, the probability of different data states of the channel input information being mapped to the respective channel output information may obey other channel functions, such as powder noise distribution function, white noise distribution function, and the like, as such, the above-mentioned probabilities may be obtained by calculation through the corresponding channel function.

As such, each channel model implementation sub-circuit 501 may include a random number generation circuit 510 and a channel output information determination circuit 520.

The random number generation circuit 510 is configured to generate a random number, for example, a random number greater than or equal to 0, and less than or equal to the random number preset value RAND_MAX.

The channel output information determination circuit 520 determines a random number interval in which the random number generated by the random number generation circuit 510 is located and channel output information corresponding to the random number interval based on the random number, a data state of the received one sub-data, and a random number interval group information under the corresponding data state.

It may be understood that the channel output information determination circuit 520 only needs to implement simple logic functions such as comparison, determination, and selection, thereby less hardware and software resources may be occupied. In some examples, the random number generation circuit 510 may be implemented by a related circuit such as a shift register; and the output information determination circuit 520 may be implemented by a related circuit such as a Multiplexer (MUX), a comparator and the like.

That is, the present disclosure may generate a mapping relationship between a plurality of random number intervals and a plurality of channel output information in advance by simulation statistics and the like. The channel model implementation circuit 500 determines channel output information corresponding to each sub-data of channel input information, based on random number interval group information including the mapping relationship above. In this way, the channel model implementation circuit 500 does not need to perform a large amount of computations, which is beneficial for saving software resources and hardware resources.

In some examples, the channel model implementation circuit 500 may be an application-specific integrated circuit (ASIC), which has the advantages of flexible design, low cost and the like.

In some examples, the channel output information determination circuit 520 is further configured to receive random number interval group information. The sub-data includes N data states, the random number interval group information includes N sub-random number interval group information in a one-to-one correspondence with the N data states, and N is an integer greater than 1. The P-th sub-random number interval group information includes a mapping relationship between a plurality of random number intervals and a plurality of channel output information, the mapping relationship corresponds to the P-th data state, P is an integer greater than or equal to 1, and P is less than or equal to N.

In an example of the present disclosure, a sub-data may include N data states, for example, 2, 4, and 8 data states corresponding to BPSK, QPSK, 8PSK, respectively, as in the examples above. As such, random number interval group information may include N sub-random number interval group information in a one-to-one correspondence with the N data states. For example, in FIG. 9, the random number interval group information includes the first sub-random number interval group information and the second sub-random number interval group information corresponding to the 2 data states “0” and “1”.

The P-th random number interval group information includes a mapping relationship between a plurality of random number intervals and the plurality of channel output information, the mapping information corresponds to the P-th data state. For example, in FIG. 9, the first random number interval group information includes a mapping relationship between a plurality of random number intervals and the plurality of channel output information, the mapping relationship is corresponding to the data state “0”.

In some examples, in the P-th sub-random number interval group information, a size of the random number interval is positively correlated with the probability of the P-th data state being mapped to the corresponding channel output information.

In an example of the present disclosure. referring to FIG. 9, in any one of the sub-random number interval group information, the size of the random number interval may be obtained by multiplying the random number preset value RAND_MAX with the probability of the data state being mapped to the channel output information corresponding to the random number interval. For example, in the first random number interval group, the size of the random number interval corresponding to the channel output information “−7” may be obtained by multiplying the random number preset value RAND_MAX with the probability P₀₍₋₇₎. As such, if the probability P₀₍₋₇₎ is larger, the random number interval corresponding to the channel output information “−7” is larger, a probability that a random number generated by the random number generation circuit 510 falls within the random number interval is greater, a probability that the channel model implementation sub-circuit 501 outputs the channel output information “−7” is greater.

In some examples, the channel output information determination circuit 520 is configured to: determine random number interval(s) corresponding to a random number in the first sub-random number interval group information to the N-th sub-random number interval group information, and determine channel output information corresponding to a sub-data based on the random number interval in which the random number is located and a data state of the sub-data.

In an example of the present disclosure, the channel output information determination circuit 520 may determine N random number intervals corresponding to a random number generated by the random number generation circuit 510 in the first random number interval group information to the N-th random number interval group information. Then, the channel output information determination circuit 520 may determine channel output information corresponding to one of the N random number intervals based on a data state of the sub-data.

For example, referring to FIG. 9, the channel output information determination circuit first determines that a random number generated by the random number generation circuit falls within the random number interval RAND_MAX*P₀₍₋₇₎ in the first random number interval group information, and determines that the random number falls within the random number interval RAND_MAX*P₁₍₊₇₎ in the second random number interval group information, so as to output the channel output information “−7” corresponding to the random number interval RAND_MAX*P₀₍₋₇₎ and the channel output information “+7” corresponding to the random number interval RAND_MAX*P₁₍₊₇₎. Then, according to the data state of the sub-data, the channel output information determination circuit selects and outputs the channel output information “−7” when the data state is “0”, or selects and outputs the channel output information “+7” when the data state is “1”.

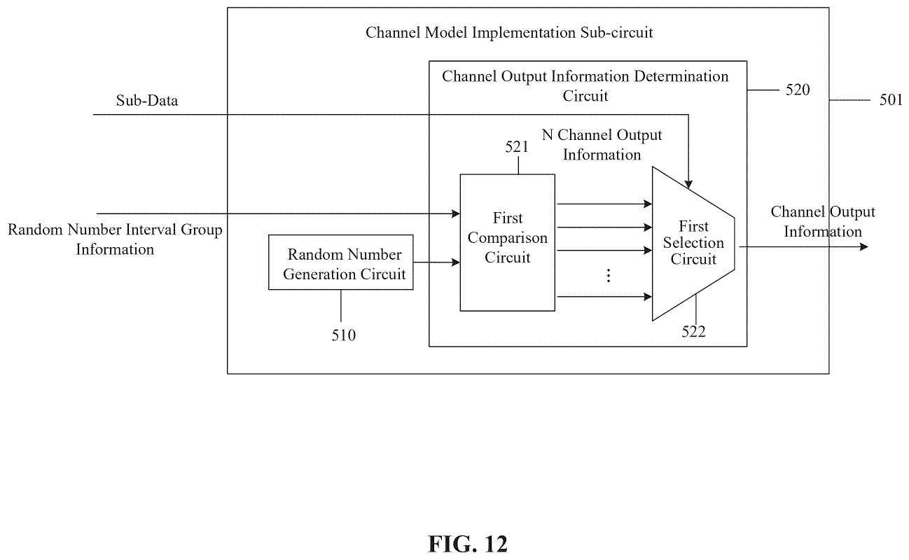

In some examples, as shown in FIG. 12, the channel output information determination circuit 520 includes a first comparison circuit 521. The first comparison circuit 521 is configured to compare a random number with a plurality of random number intervals in each sub-random number interval group information. The first comparison circuit 521 is configured to determine N random number intervals corresponding to the random number in the first sub-random number interval group information to the N-th sub-random number interval group information. The first comparison circuit 521 is configured to output N channel output information corresponding to the N random number intervals. The channel output information determination circuit 520 includes a first selection circuit 522, which is configured to output one of the N channel output information based on a data state of the sub-data.

In an example of the present disclosure, the channel output information determination circuit 520 includes a first comparison circuit 521 and a first selection circuit 522. The first comparison circuit 521 is configured to compare a random number generated by the random number generation circuit with a plurality of random number intervals in the first sub-random number interval group information to the N-th sub-random number interval group information, so as to determine N random number intervals corresponding to the random number in the first sub-random number interval group information to the N-th sub-random number interval group information, and output N channel output information corresponding to the N random number intervals.

For example, referring to FIG. 9, the first comparison circuit compares the random number with the plurality of random number intervals in the first random number interval group information, so as to determine that the random number falls within the random number interval RAND_MAX*P₀₍₋₇₎, and outputs the corresponding channel output information “−7”; the first comparison circuit compares the random number with the plurality of random number intervals in the second random number interval group information, so as to determine that the random number falls within the random number interval RAND_MAX*P₁₍₊₇₎, and outputs the corresponding channel output information “+7”.

The first selection circuit 522 is configured to select and output one of the N channel output information based on the data state of the sub-data. For example, the first selection circuit 522 selects and outputs the channel output information “−7” of the first sub-random number interval group information based on the data state of the sub-data being “0”; or the first selection circuit 522 selects and outputs the channel output information “+7” of the second sub-random number interval group information based on the data state of the sub-data being “1”. In some examples, the first comparison circuit 521 may include one or more comparators, and the first selection circuit 522 may include a multiplexer.

In some examples, the sub-data includes a first data state and a second data state, the probability of the first data state being mapped to the channel output information n may be equal to the probability of the second data state being mapped to the channel output information m, where n+m=0, n and m are both integers. The first data state corresponds to the first sub-random number interval group information, and the second data state corresponds to the second sub-random number interval group information. The plurality of random number intervals in the first sub-random number interval group information may be the same as the plurality of random number intervals in the second sub-random number interval group information. The channel output information in the first sub-random number interval group information and the channel output information in the second sub-random number interval group information that correspond to a same random number interval may be complementary to each other. The first comparison circuit 521 is configured to compare a random number with the plurality of random number intervals in the first sub-random number interval group information, determine a random number interval corresponding to the random number. The first comparison circuit 521 is configured to output the first channel output information corresponding to the random number interval. The first selection circuit 522 is configured to output the first channel output information based on a data state of the sub-data being the first data state; or the first selection circuit 522 is configured to output the inverted first channel output information based on the data state of the sub-data being the second data state.

In an example of the present disclosure, the sub-data may include two data states, and the probability of the first data state being mapped to the channel output information n may be equal to the probability of the second data state being mapped to the channel output information m, and n+m=0, for example, P₀₍ₓ₎=P_{1(y)} in the symmetric channel shown in FIG. 11. In this case, the plurality of random number intervals in the first sub-random number interval group information and in the second sub-random number interval group information may be the same, and two channel output information in the first sub-random number interval group information and in the second sub-random number interval group information which are complementary may correspond to a same random number interval.

For example, referring to FIG. 9, in the case of symmetric channel, the random number interval RAND_MAX*P₀₍₋₇₎ corresponding to the channel output information “−7” in the first sub-random number interval group information and the random number interval RAND_MAX*P₁₍₊₇₎ corresponding to the channel output information “+7” in the second sub-random number interval group information are the same random number interval, this is due to the probability P₀₍₋₇₎=P₁₍₊₇₎, the sizes of the corresponding random number intervals may also be equal.

As such, the plurality of random number intervals in the first sub-random number interval group information are the same as the plurality of random number intervals in the second sub-random number interval group information, so the first comparison circuit 521 would only need to compare a random number with the plurality of random number intervals of any one of the first or the second sub-random number interval group information.

For example, the first comparison circuit 521 may compare the random number with the plurality of random number intervals in the first sub-random number interval group information, determine a random number interval corresponding to the random number, and output first channel output information corresponding to the random number interval (for example, the channel output information “−7” corresponding to the random number interval RAND_MAX*P₀₍₋₇₎). The first selection circuit 522 outputs the first channel output information based on the data state of the sub-data being the first data state; or outputs the inverted first channel output information based on the data state of the sub-data being the second data state. For example, the first selection circuit 522 directly outputs the channel output information “−7” based on the data state of the sub-data being “0”, or the first selection circuit 522 outputs the inverted channel output information “+7” based on the data state of the sub-data being “1”.

In some examples, the channel output information determination circuit 520 is configured to determine one sub-random number interval group information corresponding to the sub-data in the N sub-random number interval group information based on a data state of the sub-data. The channel output information determination circuit 520 is configured to determine a random number interval corresponding to a random number in the sub-random number interval group information. The channel output information determination circuit 520 is configured to output the channel output information corresponding to the random number interval.

In an example of the present disclosure, the channel output information determination circuit 520 may first select one sub-random number interval group information corresponding to a data state of the sub-data from the N random number interval group information, based on the data state of the sub-data.

For example, referring to FIG. 9, when the data state of the sub-data being “0”, the channel output information determination circuit selects and outputs the first sub-random number interval group information; and when the data state of the sub-data being “1”, the channel output information determination circuit selects and outputs the second sub-random number interval group information. Then, the channel output information determination circuit 520 may determine a random number interval corresponding to the random number in the sub-random number interval group information, and output corresponding channel output information. For example, referring to FIG. 9, when the data state of the sub-data being “0”, the channel output information determination circuit determines that the random number falls within the random number interval RAND_MAX*P₀₍₋₇₎ in the first sub-random number interval group information, so as to output the corresponding channel output information “−7” (the case where the data state of the sub-data being “1” would not be discussed here again).

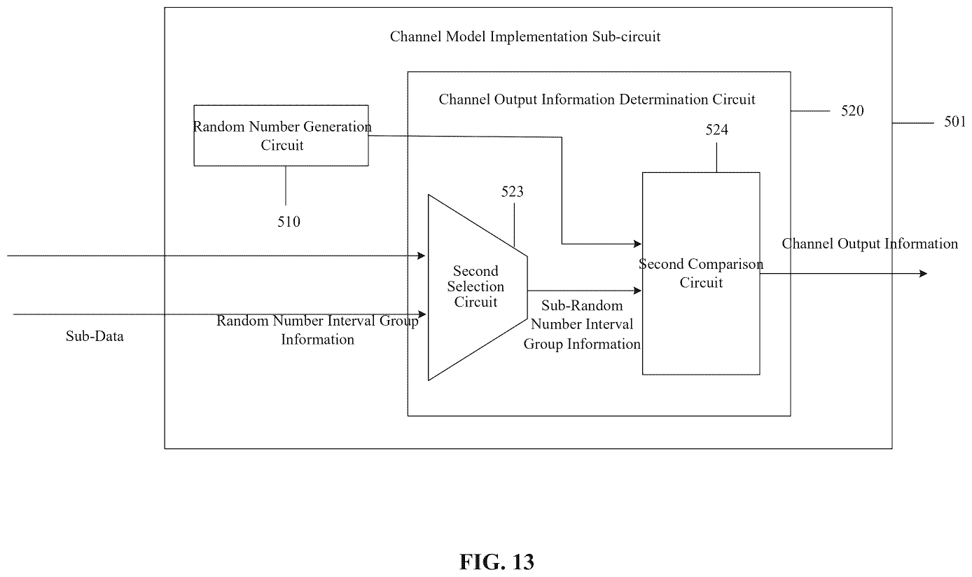

In some examples, as shown in FIG. 13, the channel output information determination circuit 520 includes a second selection circuit 523 and a second comparison circuit 524. The second selection circuit 523 is configured to output one sub-random number interval group information corresponding to the data state of the sub-data in the N sub-random number interval group information based on the data state of the sub-data. The second comparison circuit 524 is configured to compare the random number with the plurality random number intervals in one sub-random number interval group information. The second comparison circuit 524 is configured to determine a random number interval corresponding to the random number. The second comparison circuit 524 is configured to output the channel output information corresponding to the random number interval.

In an example of the present disclosure, the channel output information determination circuit 520 includes a second selection circuit 523 and a second comparison circuit 524. The second selection circuit 523 is configured to select one sub-random number interval group information corresponding to a data state of the sub-data in the N sub-random number interval group information based on the data state. The second comparison circuit 524 is configured to compare a random number with a plurality of random number intervals in the sub-random number interval group information output by the second selection circuit 523 to determine a random number interval corresponding to the random number and channel output information.

For example, referring to FIG. 9, when the data state of the sub-data being “0”, the second selection circuit 523 selects and outputs the first sub-random number interval group information, the second comparison circuit 524 compares the random number with the plurality of random number intervals in the first sub-random number interval group information, determines that the random number falls within the random number interval RAND_MAX*P₀₍₋₇₎, so as to output the corresponding channel output information “−7”; when the data state of the sub-data being “1”, the second selection circuit 523 selects and outputs the second sub-random number interval group information, the second comparison circuit 524 compares the random number with the plurality of random number intervals in the second sub-random number interval group information, determines that the random number falls within the random number interval RAND_MAX*P₁₍₊₇₎, so as to output the corresponding channel output information “+7”.

In some examples, the second comparison circuit 524 may include one or more comparators, and the second selection circuit 523 may include a multiplexer.

Referring to FIG. 12 and FIG. 13, the channel model implementation sub-circuit 501 comprises the random number generation circuit 510 and the channel output information determination circuit 520.

In some examples, as shown in FIG. 8, the channel model implementation circuit 500 further includes a storage component 502. The storage component 502 is configured to store the random number interval group information.

In an example of the present disclosure, the storage component 502 is configured to store the random number interval group information, which may be generated in advance by simulation statistics, formula derivation calculation, and the like. The storage component 502 includes but is not limited to, SRAM, SSRAM, DRAM, SDRAM, DDR, ESDRAM, SLDRAM, DRRAM, FRAM, NAND Flash, NOR Flash, and the like.

In some examples, the sub-data includes Q bits, the sub-data includes 2^{Q} data states, and Q is a positive integer.

In an example of the present disclosure, when the channel model adopts BPSK, the sub-data may include 1 bit, e.g., 2 data states of “0” and “1”; when the channel model adopts QPSK, the sub-data may include 2 bits, that is, 4 data states of “00”, “01”, “10”, and “11”; when the channel model adopts 8PSK, the sub-data may include 3 bits, that is, 8 data states of “000”, “001”, “010”, “011”, “100”, “101”, “110”, and “111”. It may be understood that the sub-data may further include more bits, and details will not be discussed here again.

In some examples, the channel input information includes encoded data, and the channel output information includes the noised fixed-point log-likelihood ratio.

In an example of the present disclosure, the channel model may be BPSK and AWGN channel model; in this case, the channel input information may be encoded data generated by the encoding circuit, and the channel output information may be noised fixed-point LLR.

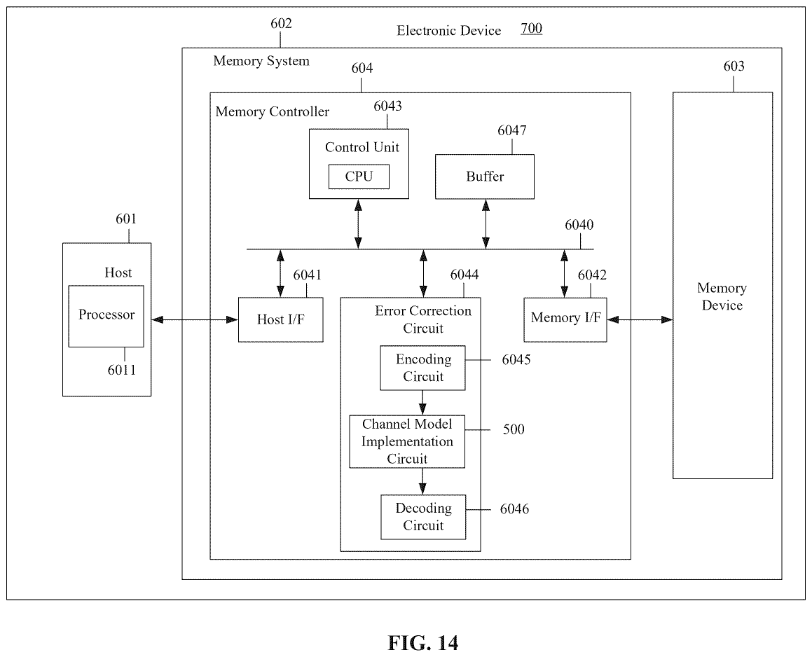

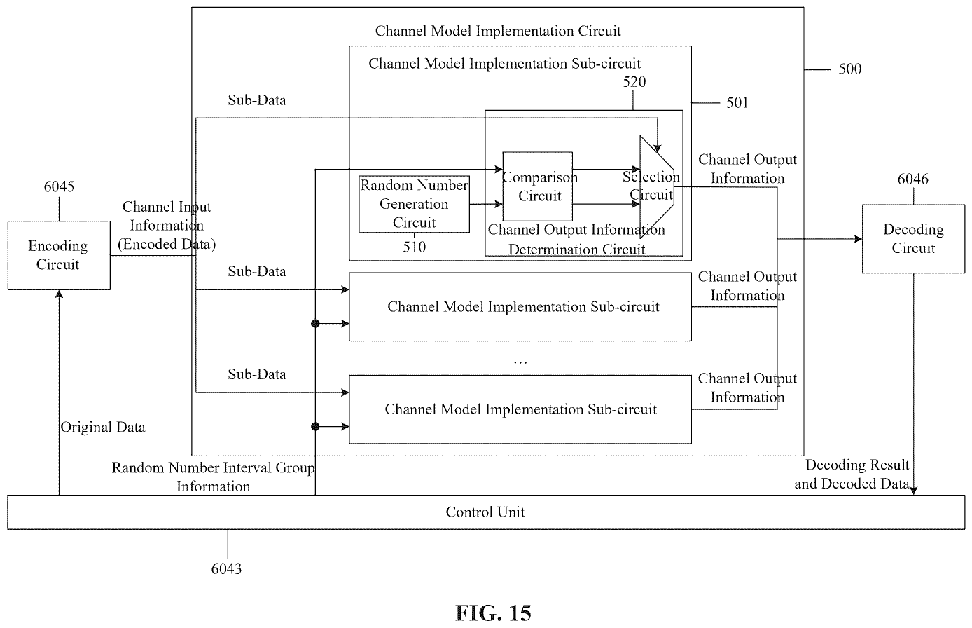

Based on the channel model implementation circuit above, as shown in FIG. 14 and FIG. 15, an example of the present disclosure further provides a memory controller 604. The memory controller 604 includes a host interface (I/F) 6041, a memory interface (I/F) 6042, buffer 6047, a bus 6040, an error correction circuit 6044 and a control unit 6043. The error correction circuit 6044 includes the channel model implementation circuit 500 in the above example, an encoding circuit 6045, and a decoding circuit 6046. The control unit 6043 is configured to output original data. The encoding circuit 6045 is configured to encode the original data to generate channel input information. The decoding circuit 6046 is configured to obtain decoded data based on a check matrix to be tested and channel output information corresponding to each sub-data of the channel input information. The channel model implementation 500 comprises at least one channel model implementation sub-circuit 501, the channel model implementation sub-circuit 501 comprises the random number generation circuit 510 and the channel output information determination circuit 520.

The memory controller 604 herein may be understood with reference to the memory controller 104 shown in FIGS. 1-3 and 6. Other details about the memory controller are described above in detail, and details will not be discussed here again for brevity.

The control unit 6043 outputs original data. The encoding circuit 6045 encodes the original data to generate channel input information. The channel model implementation circuit 500 generates channel output information based on the channel input information and the random number interval group information. The decoding circuit 6046 obtains the decoded data and a decoding result based on the check matrix to be tested and the channel output information. As such, the memory controller 604 may perform soft decoding performance test on the check matrix to be tested.

It may be understood that, according to aspects of the present disclosure, as a mapping relationship between the plurality of random number intervals and the plurality of channel output information may be generated in advance by simulation statistics, the channel model implementation circuit 500 may directly determine the channel output information corresponding to each sub-data of the channel input information based on the random number interval group information including the above mapping relationship. In this way, the channel model implementation circuit 500 does not need to perform an undue number of computations, which is beneficial for saving software resources and hardware resources of the memory controller 604.

In some examples, the control unit 6043 is further configured to compare the decoded data with the original data. The control unit 6043 is further configured to output a decoding performance test result. The control unit 6043 is further configured to determine a check matrix for a decoding operation based on decoding performance test results corresponding to a plurality of check matrices to be tested.

In an example of the present disclosure, the control unit 6043 may perform decoding performance test on a plurality of check matrices to be tested, and determine one of the plurality of check matrices to be tested as a check matrix to be used by the memory controller 604 to perform the decoding operation in practice based on the decoding performance test results of the plurality of check matrices to be tested.

In some examples, after performing the decoding performance test on the check matrix to be tested, parameters of the check matrix to be tested may be further tuned based on its decoding performance test result to implement multiple iterative optimizations. The check matrix to be used by the memory controller 604 to perform the decoding operation in practice may be obtained.

In some examples, the control unit 6043 is further configured to perform simulation or calculation on user data, to determine probabilities of the user data being mapped to a plurality of channel output information. The control unit 6043 is further configured to generate a plurality of random number intervals in one-to-one correspondence with the plurality of channel output information based on the probability of the user data being mapped to the plurality of channel output information and a random number preset value. The random number preset value is greater than or equal to the random number generated by the channel model implementation sub-circuit. The control unit 6043 is further configured to generate the random number interval group information including the mapping relationship between the plurality of random number intervals and the plurality of channel output information.

In an example of the present disclosure, the control unit 6043 may obtain the random number interval group information in advance based on a large amount of user data by simulation statistics, formula derivation calculation, and the like. For example, the control unit 6043 may perform a BPSK and AWGN channel model simulation on the user data to calculate probabilities of different data states of the sub-data of the channel input information (encoded data) being mapped to respective channel output information (noised fixed-point LLR).

FIG. 10 illustrates that under BPSK and AWGN channel model, probabilities P₀₍₋₇₎, P₀₍₋₆₎, P₀₍₋₅₎ . . . P₀₍₊₅₎, P₀₍₊₆₎, and P₀₍₊₇₎ of the sub-data of data state “0” being mapped to the noised fixed-point LLR values −7, −6, −5 . . . +5, +6, and +7 respectively, and probabilities P₁₍₋₇₎, P₁₍₋₆₎, P₁₍₋₅₎ . . . P₁₍₊₅₎, P₁₍₊₆₎, and P₁₍₊₇₎ of the sub-data of data state “1” being mapped to the noised fixed-point LLR values −7, −6, −5 . . . +5, +6, and +7 respectively. It may be understood that the above probabilities may be obtained by performing channel model simulation calculation on the user data by the control unit. As such, based on the probabilities of different data states of the channel input information being mapped to respective channel output information, and a set random number preset value RAND_MAX (that is, a maximum random value), a plurality of random number intervals as shown in FIG. 9 may be obtained (e.g., multiplying the random number preset value with each probability to obtain a size of a corresponding random number interval, then performing accumulation calculation to obtain an upper limit value and a lower limit value of each random number interval), and each random number interval may correspond to one noised fixed-point LLR value. In some examples, the probabilities of different data states being mapped to respective channel output information may be a cumulative probability.

In some examples, the control unit 6043 is configured to: perform an operation on the random number preset value and the probabilities of the user data being mapped to the plurality of channel output information respectively to obtain a plurality of random number intervals in one-to-one correspondence with the plurality of channel output information; and generate a random number interval based on the size of the random number interval.

In an example of the present disclosure, referring to FIG. 9, the control unit may multiply the random number preset value RAND_MAX with each probability to obtain the size of the corresponding random number interval, and then perform accumulation calculation to obtain the upper limit value or the lower limit value of each random number interval. Further, the control unit may generate the corresponding random number interval based on the upper limit value and the lower limit value of the random number interval.

In some examples, the control unit 6043 is configured to perform calculation on the user data with a channel function. The control unit 6043 is configured to determine the probabilities of each data state of the user data being mapped to the plurality of channel output information.

In an example of the present disclosure, as shown in FIG. 11, the probabilities of different data states of the channel input information being mapped to respective channel output information obey a normal distribution, therefore the above probabilities P₀₍₋₇₎, P₀₍₋₆₎, P₀₍₋₅₎ . . . P₀₍₊₅₎, P₀₍₊₆₎, P₀₍₊₇₎, and P₁₍₋₇₎, P₁₍₋₆₎, P₁₍₋₅₎ . . . P₁₍₊₅₎, P₁₍₊₆₎, P₁₍₊₇₎ can be obtained by theoretical calculation through a cumulative distribution function of the normal distribution by the control unit. It should be noted that FIG. 11 merely shows the probability distribution under BPSK and AWGN symmetric channel, and in this case, when the noised fixed-point LLR value x and the noised fixed-point LLR value y are opposite to each other (e.g., x+y=0), the probability P₀₍ₓ₎ of the data state “0” being mapped to the noised fixed-point LLR value x is equal to the probability P_{1(y)} of the data state “1” being mapped to the noised fixed-point LLR value y. In addition, the probabilities of different data states of the channel input information being mapped to the respective channel output information may obey other channel functions, e.g., such as a powder noise distribution function, a white noise distribution function, and the like. As such, the above probabilities may be obtained by theoretical calculation through the corresponding channel function.

In some examples, at least one of the encoding circuit 6045, the control unit 604, the decoding circuit 6046, and the channel model implementation circuit 500 includes an application specific integrated circuit.

In an example of the present disclosure, as the process of performing the soft decoding performance test on the check matrix to be tested would not require complex operations, at least one of the encoding circuit 6045, the control unit 604, the decoding circuit 6046 and the channel model implementation circuit 500 may include an application specific integrated circuit, thereby resulting in a simplified circuit design and lower cost.

As shown in FIG. 14, based on the above memory controller, an example of the present disclosure further provides an electronic device 700, including a processor 6011 and the memory controller 604 in the above examples. The processor 6011 is configured to generate random number interval group information; and the control unit 6043 is further configured to transmit the random number interval group information to the channel model implementation circuit 500.

In an example of the present disclosure, the electronic device 700 may be understood with reference to the system 100 in FIG. 1, and other details about the electronic device are described in detail above, and details would not be discussed here again for brevity.

The electronic device 700 includes a processor 6011, e.g., the processor 6011 may be located in the host 601. As such, the processor 6011 may also be configured to perform simulation calculation on the channel model based on a large amount of user data to generate random number interval group information. It may be understood that the operation capability of the processor 6011 in the host 601 may be stronger than the control unit 6043 in the memory controller 604. In this way, the simulation calculation efficiency may be improved to generate the random number interval group information more quickly, while at the same time saving the number of available hardware resources and software resources of the memory controller 604. The control unit 6043 is configured to transmit the random number interval group information generated by the processor 6011 to the channel model implementation circuit 500. In some examples, the control unit 6043 may temporarily store the random number interval group information to at least one of the buffer 6047 or the memory device 603, and provide the random number interval group information to the channel model implementation circuit 500 when performing the soft decoding performance test on the check matrix to be tested. For example, the memory system 602 comprises the memory controller 604 and the memory device 603.

In some examples, the processor 6011 is configured to perform simulation or calculation on the user data to determine probabilities of the user data being mapped to a plurality of channel output information. The processor 6011 is configured to generate a plurality of random number intervals in one-to-one correspondence with the plurality of channel output information based on the probabilities of the user data being mapped to the plurality of channel output information and a random number preset value. The random number preset value is greater than or equal to the random number generated by the channel model implementation sub-circuit. The processor 6011 is configured to generate random number interval group information including the mapping relationship between the plurality of random number intervals and the plurality of channel output information.

In some examples, the processor 6011 is configured to perform an operation on the random number preset value and the probabilities of the user data being mapped to the plurality of channel output information respectively to obtain sizes of the plurality of random number intervals in one-to-one correspondence with the plurality of channel output information. The processor 6011 is configured generate a random number interval based on the sizes of the random number intervals.

In some examples, the processor 6011 is configured to perform calculation on the user data with a channel function. The processor 6011 is configured to determine probabilities of each data state of the user data being mapped to the plurality of channel output information respectively.

The process that the processor 6011 generates the random number interval group information in the above example has been described in detail in the related examples of the memory controller 604, and details would not be discussed here again for brevity.

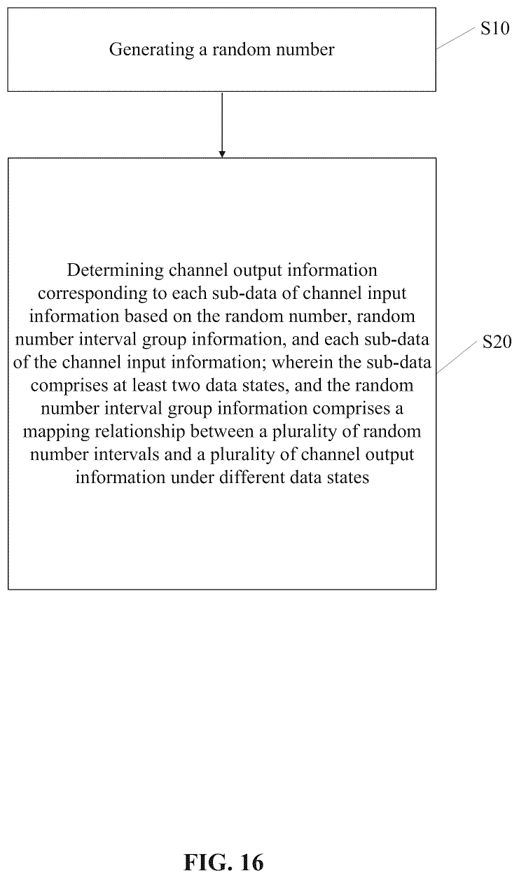

Based on the above channel model implementation circuit, an example of the present disclosure further provides a channel model implementation method. As shown in FIG. 16, the channel model implementation method includes, e.g., operations S10 and S20.

At operation S10, a random number is generated.

At operation S20, channel output information corresponding to each sub-data of channel input information is determined based on the random number, random number interval group information, and each sub-data of the channel input information. The sub-data includes at least two data states, and the random number interval group information includes a mapping relationship between a plurality of random number intervals and a plurality of channel output information under different data states.

In an example of the present disclosure, the mapping relationship between the plurality of random number intervals and the plurality of channel output information may be generated in advance by simulation statistics and the like, and then the channel output information corresponding to each sub-data of the channel input information is determined directly based on the random number interval group information, the random number interval group information includes the above mapping relationship, so that the channel model implementation method does not need to perform a large amount of computations, which would be beneficial for saving software resources and hardware resources.

In some examples, the channel model implementation method further includes: receiving the random number interval group information. The sub-data includes N data states, the random number interval group information includes N sub-random number interval group information in a one-to-one correspondence with the N data states, and N is an integer greater than 1; a P-th sub-random number interval group information includes a mapping relationship between a plurality of random number intervals and a plurality of channel output information, the mapping relationship is corresponding to the P-th data state, P is an integer greater than or equal to 1, and P is less than or equal to N.

In some examples, in the P-th sub-random number interval group information, a size of the random number interval is positively correlated with a probability of the P-th data state being mapped to the corresponding channel output information.

In some examples, generating the random number includes: generating a plurality of random numbers, where a number of the random numbers is the same as a number of sub-data of the channel input information; determining the channel output information corresponding to each sub-data of the channel input information, based on the random number, the random number interval group information, and the channel input information, includes: determining a random number interval corresponding to each random number in a first sub-random number interval group information to a N-th sub-random number interval group information; and determining the channel output information corresponding to each sub-data of the channel input information, based on the random number interval in which each random number is located and the data state of each sub-data of the channel input information.

In some examples, determining the random number interval corresponding to each random number in the first sub-random number interval group information to the N-th sub-random number interval group information, includes: comparing the random number with a plurality of random number intervals in each sub-random number interval group information, and determining N random number intervals corresponding to the random number in the first sub-random number interval group information to the N-th sub-random number interval group information; and determining channel output information corresponding to each sub-data of the channel input information based on the random number interval in which each random number is located and the data state of each sub-data in the channel input information, includes: outputting N channel output information corresponding to the N random number intervals; and outputting one of the N channel output information based on the data state of one sub-data of the channel input information.

In some examples, the sub-data includes a first data state and a second data state, a probability of the first data state being mapped to the channel output information n is equal to a probability of the second data state being mapped to the channel output information m, where n+m=0, n and m are both integers; the first data state corresponds to the first sub-random number interval group information, and the second data state corresponds to the second sub-random number interval group information; a plurality of random number intervals in the first sub-random number interval group information are the same as a plurality of random number intervals in the second sub-random number interval group information; the channel output information in the first sub-random number interval group information and the channel output information in the second sub-random number interval group information corresponding to a same random number interval are complementary; the channel model implementation method includes: comparing the random number with the plurality of random number intervals in the first sub-random number interval group information, determining a random number interval corresponding to the random number, and outputting the first channel output information corresponding to the random number interval; outputting the first channel output information based on the data state of one sub-data of the channel input information being the first data state; or, outputting inverted version of the first channel output information based on the data state of one sub-data of the channel input information being the second data state.

In some examples, generating the random number, includes: generating a plurality of random numbers, where a number of the random numbers is the same as a number of sub-data of the channel input information; and determining the channel output information corresponding to each sub-data of the channel input information based on the random number, the random number interval group information, and the channel input information, includes: determining one sub-random number interval group information corresponding to each sub-data in the N sub-random number interval group information, based on the data state of each sub-data; and determining a random number interval corresponding to each random number in the sub-random number interval group information, and outputting the channel output information corresponding to the random number interval.

The channel model implementation method mentioned in the above example has been described in detail in the above examples of the channel model implementation circuit, and details would not be discussed here again for brevity.

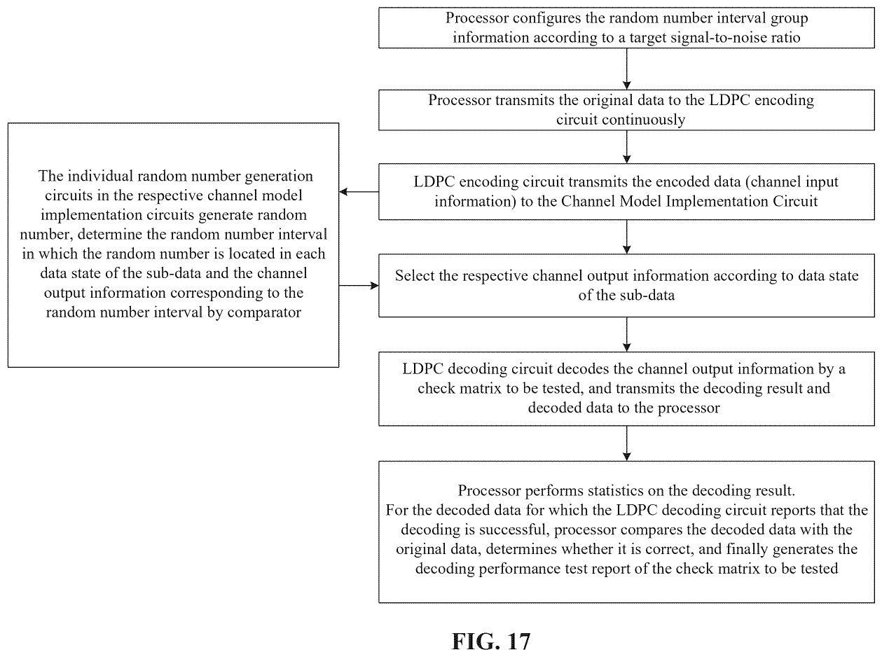

FIG. 17 is a schematic flowchart of performing a soft decoding performance test on an LDPC code check matrix according to the present disclosure, and detailed operations thereof have been introduced in the above examples, and will not be discussed here again.

Based on the above memory controller, an example of the present disclosure further provides a memory system, including: at least one memory device; the memory controller in the above example, coupled to the at least one memory device and configured to control the memory device.

The structure and components of the memory system herein may be described in detail with reference to FIG. 1 to FIG. 6 and FIG. 14, and details would not be discussed here again for brevity. The memory device herein may be the memory device 103 as shown in FIG. 1 to FIG. 6, and the memory device 603 described in FIG. 14.

The features disclosed in the several device examples provided by the present disclosure may be arbitrarily combined without conflict, so as to obtain a new device example.

The methods disclosed in the several method examples provided by the present disclosure may be arbitrarily combined without conflict, so as to obtain a new method example.

The above descriptions are merely implementations of the present disclosure, but the scope of the present disclosure is not limited thereto, and changes or replacements that may be easily conceived by anyone skilled in the art within the technical scope of the present disclosure should be covered within the scope of the present disclosure.

What is claimed is:

1. A channel model implementation circuit, comprising:
at least one channel model implementation sub-circuit, comprising:
a random number generation circuit configured to:
generate a random number; and
a channel output information determination circuit configured to:
receive one sub-data of channel input information; and
determine channel output information corresponding to the sub-data, based on the random number, random number interval group information, and the sub-data,
wherein the sub-data comprises at least two data states, and the random number interval group information comprises a mapping relationship between a plurality of random number intervals and a plurality of channel output information under different data states.

2. The channel model implementation circuit of claim 1, wherein the channel output information determination circuit is further configured to:
receive the random number interval group information,
wherein the sub-data comprises N data states, the random number interval group information comprises N sub-random number interval group information in a one-to-one correspondence with the N data states, and N is an integer greater than 1, and
wherein a P-th sub-random number interval group information comprises a mapping relationship, corresponding to a P-th data state, between the plurality of random number intervals and the plurality of channel output information, and P is an integer greater than or equal to 1, and less than or equal to N.

3. The channel model implementation circuit of claim 2, wherein in the P-th sub-random number interval group information, a size of the random number interval is positively correlated with a probability of the P-th data state being mapped to corresponding channel output information.

4. The channel model implementation circuit of claim 2, wherein the channel output information determination circuit is configured to:
determine the random number interval corresponding to the random number in a first sub-random number interval group information to a N-th sub-random number interval group information; and
determine the channel output information corresponding to the sub-data based on the random number interval in which the random number is located and a data state of the sub-data.

5. The channel model implementation circuit of claim 4, wherein the channel output information determination circuit comprises:
a first comparison circuit configured to:
compare the random number with the plurality of random number intervals in each sub-random number interval group information;
determine N random number intervals corresponding to the random number in the first sub-random number interval group information to the N-th sub-random number interval group information; and
output N channel output information corresponding to the N random number intervals; and
a first selection circuit configured to:
output one of the N channel output information based on the data state of the sub-data.

6. The channel model implementation circuit of claim 5, wherein:
the sub-data comprises a first data state and a second data state,
a probability of the first data state being mapped to channel output information n is equal to a probability of the second data state being mapped to channel output information m, wherein n+m=0, and n and m are both integers,
the first data state corresponds to first sub-random number interval group information, and the second data state corresponds to second sub-random number interval group information,
the plurality of random number intervals in the first sub-random number interval group information are the same as the plurality of random number intervals in the second sub-random number interval group information,
channel output information in the first sub-random number interval group information and channel output information in the second sub-random number interval group information corresponding to a same random number interval are complementary,
the first comparison circuit is configured to:
compare the random number with the plurality of random number intervals in the first sub-random number interval group information;
determine a random number interval corresponding to the random number; and
output a first channel output information corresponding to the random number interval, and
the first selection circuit is configured to:
output the first channel output information based on the data state of the sub-data being the first data state; or
output an inverted version of the first channel output information based on the data state of the sub-data being the second data state.

7. The channel model implementation circuit of claim 2, wherein the channel output information determination circuit is configured to:
determine one sub-random number interval group information corresponding to the sub-data in the N sub-random number interval group information, based on a data state of the sub-data; and
determine the random number interval corresponding to the random number in the sub-random number interval group information, and
output the channel output information corresponding to the random number interval.

8. The channel model implementation circuit of claim 7, wherein the channel output information determination circuit comprises:
a second selection circuit configured to:
output one sub-random number interval group information corresponding to the data state of the sub-data in the N sub-random number interval group information based on the data state of the sub-data; and
a second comparison circuit configured to:
compare the random number with the plurality of random number intervals in the one sub-random number interval group information;
determine the random number interval corresponding to the random number; and
output the channel output information corresponding to the random number interval.

9. The channel model implementation circuit of claim 1, further comprising:
a storage component configured to store the random number interval group information.

10. The channel model implementation circuit of claim 1, wherein the sub-data comprises Q bits, the sub-data comprises 2^{Q} data states, and Q is a positive integer.

11. The channel model implementation circuit of claim 1, wherein the channel input information comprises encoded data, and the channel output information comprises a noised fixed-point log-likelihood ratio.

12. A memory controller, comprising:
an error correction circuit, comprising;
a channel model implementation circuit, comprising:
at least one channel model implementation sub-circuit, comprising:
a random number generation circuit, configured to: generate a random number; and
a channel output information determination circuit configured to: receive one sub-data of channel input information; and determine channel output information corresponding to the sub-data, based on the random number, random number interval group information, and the sub-data; wherein the sub-data comprises at least two data states, and the random number interval group information comprises a mapping relationship between a plurality of random number intervals and a plurality of channel output information under different data states;
an encoding circuit; and
a decoding circuit; and
a control unit configured to output original data,
wherein the encoding circuit is configured to encode the original data to generate the channel input information, and the decoding circuit is configured to obtain decoded data based on a check matrix to be tested and the channel output information corresponding to each sub-data of the channel input information.

13. The memory controller of claim 12, wherein the control unit is further configured to:
perform simulation or calculation on user data, to determine probabilities of the user data being mapped to the plurality of channel output information;
generate the plurality of random number intervals in one-to-one correspondence with the plurality of channel output information based on probabilities of the user data being mapped to the plurality of channel output information and a random number preset value; wherein the random number preset value is greater than or equal to a random number generated by the channel model implementation sub-circuit; and
generate the random number interval group information comprising the mapping relationship between the plurality of random number intervals and the plurality of channel output information.

14. The memory controller of claim 13, wherein the control unit is configured to:
perform an operation on the random number preset value and probabilities of the user data being mapped to the plurality of channel output information respectively, to obtain sizes of a plurality of random number intervals in one-to-one correspondence with the plurality of channel output information; and
generate the random number intervals based on the sizes of the random number intervals.

15. The memory controller of claim 13, wherein the control unit is configured to:
perform calculation on the user data with a channel function, and determine probabilities of each data state of the user data being mapped to the plurality of channel output information.

16. The memory controller of claim 12, wherein the control unit is further configured to:
compare the decoded data with the original data, and output a decoding performance test result; and
determine a check matrix for a decoding operation based on decoding performance test results corresponding to a plurality of check matrices to be tested.

17. The memory controller of claim 12, wherein at least one of the encoding circuit, the control unit, the decoding circuit, and the channel model implementation circuit comprises an application specific integrated circuit.

18. A method of channel model implementation, comprising:
generating a random number; and
determining channel output information corresponding to each sub-data of channel input information based on the random number, random number interval group information, and each sub-data of the channel input information,
wherein the sub-data comprises at least two data states, and the random number interval group information comprises a mapping relationship between a plurality of random number intervals and a plurality of channel output information under different data states.

19. The method of claim 18, further comprising:
receiving the random number interval group information;
wherein the sub-data comprises N data states, the random number interval group information comprises N sub-random number interval group information in a one-to-one correspondence with the N data states, and N is an integer greater than 1, and
wherein a P-th sub-random number interval group information comprises a mapping relationship, corresponding to a P-th data state, between the plurality of random number intervals and the plurality of channel output information, and P is an integer greater than or equal to 1, and less than or equal to N.

20. The method of claim 19, wherein in the P-th sub-random number interval group information, a size of the random number interval is positively correlated with a probability of the P-th data state being mapped to corresponding channel output information.
